(19) United States
(12) Patent Application Publication
(10) Pub. No.: US 2006/0231101 A1
(43) Pub. Date: Oct. 19, 2006

(54) Assisted breathing device and method of wearing same

(76) Inventor: James L. Cannon, Clermont, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/109,504

(22) Filed: Apr. 19, 2005

(51) Int. Cl. A62B 18/08

(52) U.S. Cl. 128/206.29

(57) ABSTRACT

There is disclosed an improved breathing assistance device. The breathing assistance device comprises a lip shield attached to and spaced from an upper mouth piece such that when said upper mouth piece is positioned on said wearer's upper arch, said lip shield is positioned outside said wearer's mouth and extends to at least the vermillion border of said wearer's upper and lower lips, such that when said wearer's lips are in a pressurized position said upper and lower lips contact said lip shield and said lip shield substantially prevents air from being released through said wearer's lips. A method of using a breathing assistance device is also disclosed.

### FIELD OF THE INVENTION

The present invention relates to a device for improving the breathing of a user during sleep. Specifically, the device substantially prevents air from escaping from a person's mouth during CPAP treatment, resulting in a more efficient treatment of breathing disorders.

### BACKGROUND OF THE INVENTION

The present invention relates to an improved breathing device for delivering air under pressure to nasal passages in the treatment of breathing disorders, such as sleep apnea, ventilation difficulties or anesthetic gas administration. Sleep related breathing disorders adversely affect the breathing of individuals during periods of sleep. Sleep related breathing disorders include difficulties in sleeping, snoring, and more serious conditions, such as sleep apnea. Sleep apnea is the temporary cessation of breathing during sleep. Persons suffering from sleep apnea can stop breathing for periods as short as a few seconds, to as long as several minutes. Sleep apnea is a common disorder, affecting about a quarter of all middle-aged men in the United States, and about ten percent of middle-aged women. There are several forms of sleep apnea, including obstructive sleep apnea, central sleep apnea and mixed sleep apnea. Obstructive sleep apnea results when the flow of air in and out of the airways is blocked by upper airway obstruction. This form of sleep apnea is marked by loud snorting, snoring and gasping sounds during sleep. Central sleep apnea is caused by the absence of respiratory muscle activity. Persons suffering from this sleep apnea may exhibit excessive daytime sleepiness. Mixed apnea begins with the absence of respiratory effort and is followed by upper airway obstruction. Prolonged sleep apnea can result in headache, fatigue, and drowsiness. Other disorders include nighttime thrashing, sleepwalking, enuresis, disorientation, personality changes, intellectual deterioration, sexual dysfunction, and hypnagogic hallucinations.

Typically sleep apnea is treated by Continuous Positive Air Pressure (CPAP) therapy. For such therapy a device that forces air into an individual's air passageway to affect a slightly positive pressure of air to the nasal passages. The application of a slightly positive pressure of air is typically effective in reversing airway obstruction in patients suffering from obstructive sleep apnea.

Typically, a person suffering from sleep apnea must use CPAP therapy on a regular basis to prevent the reoccurrence of the sleep disorder. The patient typically wears a mask-like device that is connected to a CPAP device that provides an elevated or slightly positive air pressure into a patient's upper air passageway. Problems associated with CPAP treatments are sufficient to deter many patients from continuing CPAP therapy. One of the most common problem associated with CPAP therapy in use today is the expulsion of air through the user's mouth. If a user's mouth comes open, or even partially open, during CPAP therapy, the positive pressure of the air in the individual's air passageway can escape through the user's mouth. This escaping air through the mouth will dry out the lining of the mouth, throat and tongue, thereby leading to discomfort of the user.

One prior art attempt to address this problem is the use of a chin strap. The purpose of the chin strap is to prevent the mouth of the user from opening during CPAP therapy. However, merely preventing the jaw from opening does not prevent the escape of air from a user's mouth. Air can escape from a user's mouth even when the teeth are clenched shut. The air can escape through the spaces between the user's teeth or through the space between the overlap of the upper and lower arch. When a user's lips are relaxed, the air that escapes through the user's teeth pushes the lips opens slightly and escapes between the user's lips.

Another prior art attempt to solve this problem is shown in U.S. Pat. No. 6,470,886. This patent discloses the use of a lip strap that is attached to headgear worn on the user's head. The portion of the lip strap that contacts the user's lips is a folded leather portion. The leather portion of the lip strap contacts the user's lower lip and hold it against the teeth to thereby help keep air from escaping from the user's mouth. The lip strap appears to be uncomfortable to wear and difficult to adjust properly.

Another prior art attempt to solve this problem is the use of a full face mask. However, such full face masks are uncomfortable to wear and also suffers from the problems associated with proper seating of the mask on the user's face.

Various designs have been proposed to overcome some of these problems. See for example U.S. Pat. Nos. 6,752,150; 6,371,112; 6,123,082; and 5,560,354 (the disclosures of which are incorporated herein by reference). However, these devices are not entirely satisfactory and may lead to a reduced degree of compliance with the prescribed therapy.

Accordingly, there is a need for a device that reduces or eliminates the expulsion of air through a user's mouth during CPAP therapy. This in turn will result in more effective treatment of breathing disorders, such as sleep apnea.

### SUMMARY OF THE INVENTION

The present invention satisfies the above-described needs by providing a breathing assistance device, preferably for use in combination with a CPAP breathing apparatus. The device of the present invention comprises a lip shield attached to and spaced from an upper mouth piece such that when the upper mouth piece is positioned on a wearer's upper arch, the lip shield is positioned outside the wearer's mouth and extends to at least the vermillion border of the wearer's upper and lower lips, such that when the wearer's lips are in a pressurized position the upper and lower lips contact the lip shield and the lip shield substantially prevents air from being released through the wearer's lips. Preferably, the lip shield is connectable to a CPAP device.

In an alternate embodiment, there is disclosed a method comprising placing an upper mouth piece on the upper teeth of a wearer. The upper mouth piece is attached to and spaced from a lip shield positioned outside the wearer's mouth. The lip shield extends vertically to at least the vermillion border of the wearer's upper and lower lips, such that when the wearer's lips are in a pressurized position, the upper and lower lips contact the lip shield and the lip shield substantially prevents air from being released through the wearer's lips.

In yet another alternate embodiment, there is disclosed a method comprising custom molding an upper mouth piece to fit the upper arch of a wearer and custom molding a lip shield to fit the upper and lower lips of the wearer. The upper mouth piece is attached to and spaced from the lip shield, such that the upper mouth piece is positionable on the wearer's upper arch, and the lip shield is positionable outside the wearer's mouth and extends vertically to at least the vermillion border of the wearer's upper and lower lips, such that when the wearer's lips are in a pressurized position, the upper and lower lips contact the lip shield and the lip shield substantially prevents air from being released through the wearer's lips.

Accordingly, it is an object of the present invention to provide an improved breathing device.

Another object of the present invention is to provide a device for reducing or preventing air from escaping through a patient's mouth that is receiving CPAP therapy.

A further object of the present invention is to provide a device for reducing or preventing air from escaping through a patient's mouth that is receiving CPAP therapy and is relatively comfortable to wear.

These and other objects, features and advantages of the present invention will become apparent upon reviewing the following detailed description of the disclosed embodiments and the appended drawing and claims.

### BRIEF DESCRIPTION OF THE DRAWING

FIG. 1 is an exploded perspective view of a disclosed embodiment of a breathing assistance device in accordance with the present invention.

FIG. 2 is a top view of a disclosed embodiment of the lip shield device of the present invention.

FIG. 3 is a side view of a patient shown wearing the lip shield device shown in FIG. 2, the lip shield device being shown in cross-section and the patient's cheek shown in partial cut away.

FIG. 4 is a perspective view of a patient shown wearing the breathing assistance device shown in FIG. 1.

### DETAILED DESCRIPTION OF THE INVENTION

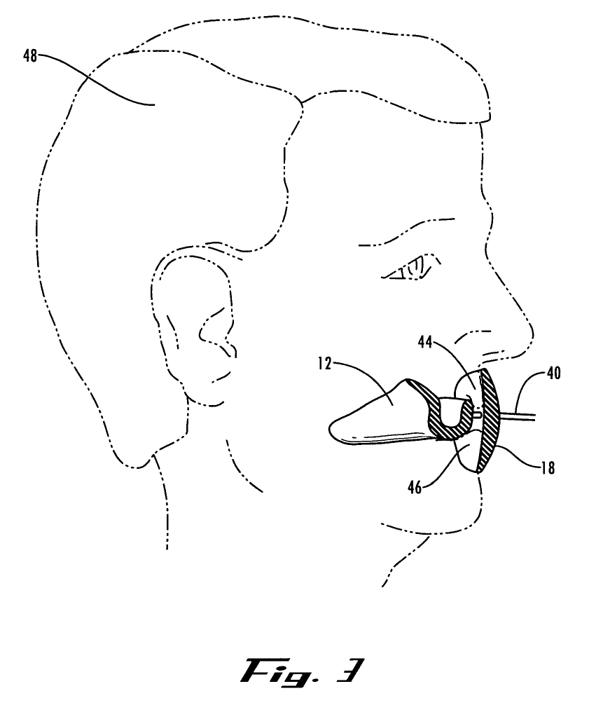

With reference to the drawing in which like numbers indicate like elements throughout the several views, it will be seen that there is a breathing assistance device 10. The breathing assistance device 10 comprises a dental appliance comprising an upper mouth piece 12 (FIG. 2) adapted to receive at least some of a user's upper teeth. The upper mouth piece 12 is preferably custom made to fit a user's teeth so that the mouth piece fits properly and is comfortable to wear. The upper mouth piece 12 is made from a composite material, or other suitable materials, typically used for dental appliances, such as dental splints, and is well know to those skilled in the art.

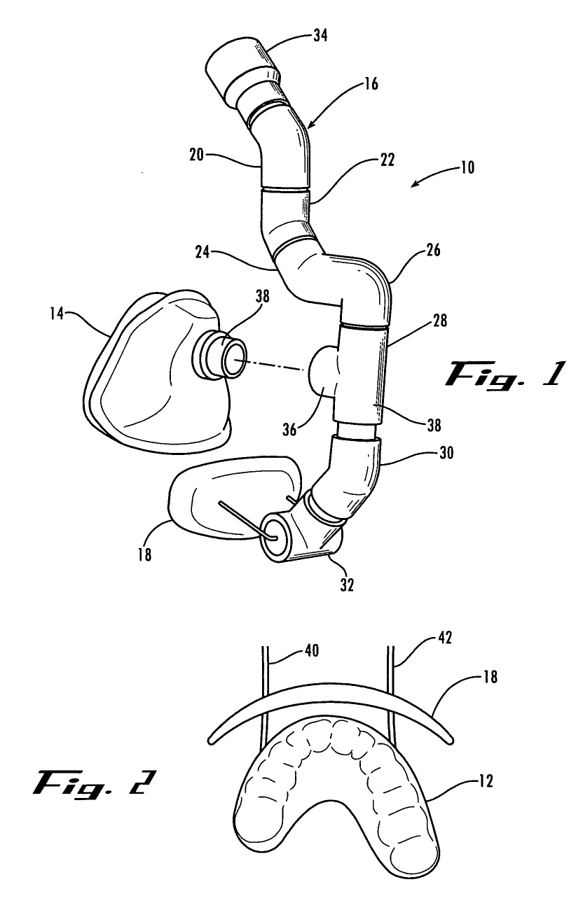

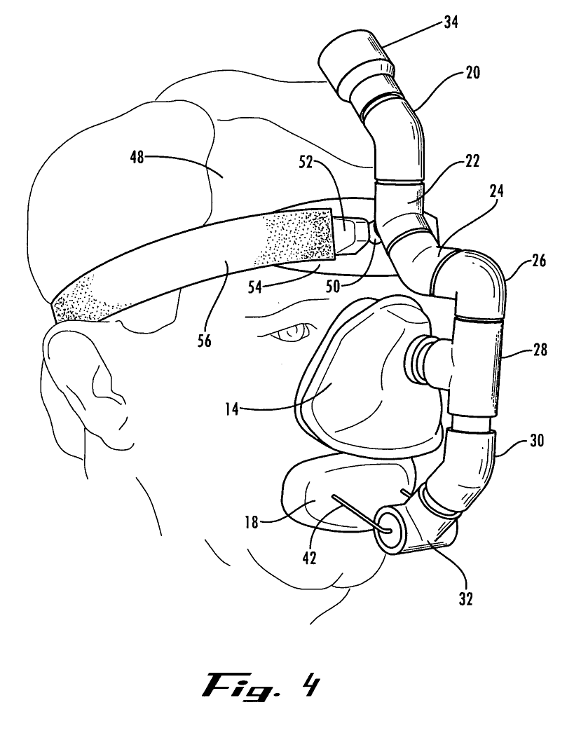

The breathing assistance device 10 also comprises a nasal mask 14 connectable to a rigid air conduit 16 and a lip shield 18. The air conduit 16 comprises a series of ¾ inch I.D. PVC pipe fittings. Each pipe fitting is attached to the adjacent pipe fitting by a piece of ¾ inch PVC pipe glued in place with PVC glue. In FIGS. 1 and 4, only the PVC pipe fittings will be referenced, but the presence of the joining PVC pipe should be understood. The air conduit 16 comprises three 45° elbows 20, 22, 24 connected in series to form an “S” shape. The elbow 24 is connected to a 90° elbow 26, which is connected to a “T” 28. The “T” 28 is connected to a 45° elbow 30 which is connected to another “T” 32. Attached to the elbow 20 is a reducer 34 which is of a suitable size to mate with a standard air hose (not shown) used with conventional CPAP devices (not shown).

The “T” 28 includes a central leg 36 and a bottom leg 38. The bottom leg 38 of the “T” 28 is preferably plugged so that air cannot escape through it. Thus, when properly connected to a CPAP device, air under positive pressure will be delivered through the reducer 34, the elbows 20, 22, 24, 26, the “T” 28 and out the central leg 36.

The mask 14 includes a fitting 38 that is designed to mate with the central leg 36 of the “T” 28 in the manner disclosed in applicant's co-pending patent application Ser. No. 10/886,931, filed Jul. 8, 2004, the disclosure of which is incorporated herein by reference. Another suitable breathing assistance device for use in the present invention is disclosed in applicant's U.S. Pat. No. 6,789,543, the disclosure of which is incorporated herein by reference. Although the breathing assistance devices disclosed in the above-referenced patent and patent application are preferred for use with the present invention, the present invention can also be used with other breathing assistance devices. When the fitting 38 is mated with the central leg 36 of the “T” 28, air under positive pressure will be delivered from the air conduit 16 to the mask 14.

With reference to FIGS. 1-3, it will be seen that there is disclosed a lip shield 18 in accordance with the present invention. The lip shield 18 comprises a curved, relatively thin piece of plastic or composite material, such as that used to make the upper mouth piece 12. The face of the lip shield 12 that engages a wearer's lip can be substantially flat in the vertical direction. However, it is preferred that the lip shield 18 be custom molded to fit the contours of the wearer's lips. A custom molded lip shield 18 can be made by first taking an impression of the wearer's lips. The impression of the wearer's lips can be made in a similar manner to taking a dental impression. A quick-setting polymeric material is placed in a holder and the wearer's lips are pressed into the uncured polymeric material in the holder. The wearer's lips are kept relatively motionless until the polymeric material is set. The holder is then removed leaving the impression of the wearer's lips in the cured polymeric material. The lip impression in the polymeric material can then be used to form a mold, and the mold can be used to cast the plastic lip shield 12. The vertical dimension of the lip shield 18 is such that it extend vertically to at least the vermillion border of the wearer's upper and lower lips. When prepared as described above, the lip shield 18 will have the precise shape and contour of the wearer's lips, thus making the lip shield more comfortable to wear for extended periods, such as overnight.

The lip shield 18 is attached to the upper mouth piece 12 by two wires 40, 42. The wires 40, 42 extend through the lip shield 18 and their free ends are embedded in the plastic or composite material from which the upper mouth piece 12 is made. Thus, when the upper mouth piece 12 is molded, the wires 40, 42 are placed in the uncured plastic or composite material and kept there until the materiel is set, thereby permanently attaching the wires to the upper mouth piece.

The wires 40, 42 are attached to the lip shield 18 by first placing the upper mouth piece 12 on the wearer's upper arch, such that the wires extend out of the wearer's mouth between the upper and lower lips. Two oversized holes are then drilled in the lip shield 18 at the approximate location at which the wires 40, 42 will pass through the lip shield. The lip shield 18 is then fit onto the wires 40, 42 by passing the wires through the two drilled holes in the lip shield. The lip shield 18 is then adjusted on the wearer's face such that the contours of the lip shield precisely match the contours of the wearer's upper 44 and lower 46 lips (FIG. 3). Furthermore, the lip shield 18 is spaced from the upper mouth piece 12 such that when the wearer's lips are in a relaxed or non-compressed position, the lip shield barely touches the wearer's upper and lower lips 44, 46. When the lip shield 18 is properly positioned on the wires 40, 42, a quick setting plastic material, preferably the same material used to make the lip shield, is placed in the holes through which the wires pass. When the plastic material is set, the lip shield 18 is permanently attached to the wires 40, 42.

In order to properly attached the lip shield to the air conduit 16, the air conduit 16 is first secured to the wearer's head 48. A flange 50 that extends outwardly from the elbow 22 is rotatably mounted on an axle (not shown) that extend between two spaced brackets 52 (only one of which is shown in FIG. 4). The brackets 52 are attached to a plate 54, the forehead engaging side of which includes a cushioning pad (not shown), such as a foam rubber pad. This bracket 52 permits the air conduit 16 to pivot in a vertical plane, but prevents tilting or twisting of the air conduit. A straps 56 secured to the plate 54 and extending around the wearer's head 48 includes hook and loop fasteners, such as Velcro® fasteners, thereby permitting the plate 54 to be adjustably and removably secured the wearer's forehead.

The “T” 32 is filled with a polymeric material. Holes for receiving the wires 40, 42 are drilled in the polymeric material in the “T” 32. With the upper mouth piece 12 and lip shield 18 in position in the wearer's mouth, the air conduit 16 comfortably secured to the wearer's head and the mask 14 positioned and properly seated on the wearer's face and the fitting 38 engaged with the central leg 36 of the “T” 28, the free ends of the wires 40, 42; i.e., the ends of the wires opposite the upper mouth piece 12, are bent inwardly toward each other at a 90° angle and the ends are then inserted in the holes in the in the polymeric material in the “T” 32. The position of the bend in the wire 40, 42 described above is carefully made so that when engaged with the holes in the polymeric material in the “T” 32, the wires will not exert any forces on the air conduit 16, the lip shield 18 or upper mouth piece 12 that would tend to move the air conduit toward or away from the wearer's face or would tend to push or pull the upper mouth piece in the wearer's mouth.

With reference to FIG. 3, the lips 44, 46 of the wearer are in what will be referred to herein as a relaxed position. The relaxed position of the lips 44, 46 is when the air in a patient's mouth is under neither a positive nor a negative air pressure, and the patient is not using his muscles to push his lips outwardly. When the patient's lips 44, 46 are in the relaxed position, as shown in FIG. 3, the lip shield 18 is constructed so that it is just barely touching the wearer's lips; i.e., not exerting any uncomfortable or annoying pressure on the wearer's lips. By just barely contacting the wearer's lips 44, 46 when in the relaxed position, the lip shield 18 is more comfortable to wear.

The present invention has been illustrated herein as comprising a series of PVC pipe fitting. These pipe fittings were used for ease of construction of a prototype working model. For commercial production, it is specifically contemplated that the air conduit 16 can be made from one or more pieces of molded plastic or other polymeric material and can be designed to have a more esthetically pleasing shape and or appearance, while still retaining the basic functionality described herein.

Use of the breathing assistance device 10 will now be considered. A CPAP device (not shown) is attached via a hose (not shown) to the reducer 34 of the air conduit 16. The plate 54 is placed on the wearer's head 48, specifically on the wearer's forehead as shown in FIG. 4, and the strap 56 is secured around the wearer's head, thereby securing the air conduit 16 to the wearer's head. The air conduit 16 is pivoted up; i.e., away from the wearer's face, and the mask 14 is placed on the wearer's face covering his nose and seating against his face so that air leaks around the periphery of the mask are prevented. The air conduit 16 is then pivoted downward; i.e., toward the wearer's face, and the fitting 38 is mated with the central leg 36 of the “T” 28 to thereby form a substantially airtight seal therebetween. As the air conduit 16 is pivoted downwardly to mate with the mask 14, the wearer opens his mouth so that the upper mouth piece 12 enters his mouth. The upper mouth piece is then seated on the wearer's upper arch. Alternatively, the joint between the elbow 30 and the “T” 28 can be removable so that the elbow 30 and the “T” 28 can be joined together after the mask 14 is mated with the elbow 28 and after the upper mouth piece 18 is seated on the wearer's upper arch. In another embodiment, after the mask 14 is mated with the elbow 28 and after the upper mouth piece 18 is seated on the wearer's upper arch, the wires 40, 42 can be inserted in the holes in the polymeric material in the “T” 32.

After the breathing assistance device 10 is positioned on the wearer's face, as described above, the air conduit 16 is supported by the flange 50 and the wires 40, 42, while the mask makes a “floating” connection with the elbow 28. No additional straps or connections are necessary to retain the mask 14 in it proper seated position on the wearer's face, thereby preventing air leaks around the periphery thereof, while permitting some relative movement between the mask and the air conduit 16.

Again, after the breathing assistance device 10 is positioned on the wearer's face, as described above, the CPAP device is turned on thereby providing air under a positive pressure to be delivered to the air conduit 16 through the connecting hose (not shown). Air flows from the connecting hose (not shown) through the reducer 34, the elbows 20-26, the “T” 28, the central leg 36 of the “T” 28, and the fitting 38 to the mask 14. The positive air pressure in the mask enters the nasal passages of the wearer in a manner well known in the art. The result is that a positive air pressure may under certain circumstances be established in the wearer's mouth. In the absence of the breathing assistance device 10 of the present invention, a positive air pressure in the wearer's mouth will push outwardly on the wearer's cheeks and lips (referred to herein as a pressurized condition), usually resulting in air escaping between the wearer's upper 44 and lower 46 lips. However, when the upper mouth piece 12 and lip shield 18 are positioned on the wearer's face, as described above, when the wearer's lips are in a pressurized condition, the lip shield prevents the upper 44 and lower 46 lips from moving outwardly and/or from separating, thereby preventing air from escaping between the upper and lower lips or reducing the amount of air that escapes between the upper and lower lips. By reducing or preventing air from escaping between the upper 44 and lower 46 lips of the wearer, excessive drying of the mouth, tongue and lips does not result. This makes the breathing assistance device 10 of the present invention more comfortable to wear, which should result in better compliance with a CPAP therapy regimen.

As used herein the term substantially prevents air from being released through said wearer's lips shall means that air is completely prevented from escaping between the upper and lower lips of a wearer of the present invention or the amount of air that escapes between the upper and lower lips of a wearer is reduced such that drying of the mouth, tongue and lips does not result to such an extent as to make using the breathing assistance device uncomfortable, undesirable or discourages the use of the breathing assistance device.

While the present invention has been described as having the upper mouth piece 12 and the lip shield 18 connected to the air conduit 16, it is specifically contemplated that the upper mouth piece and the lip shield can be used alone or with other designs of CPAP devices and nasal masks that would not permit a connection therebetween.

It should be understood, of course, that the foregoing relates only to certain disclosed embodiments of the present invention and that numerous modifications or alterations may be made therein without departing from the spirit and scope of the invention as set forth in the appended claims.

1. A device comprising a lip shield attached to and spaced from an upper mouth piece such that when said upper mouth piece is positioned on a wearer's upper arch, said lip shield is positioned outside said wearer's mouth and extends to at least the vermillion border of said wearer's upper and lower lips, such that when said wearer's lips are in a pressurized position, said upper and lower lips contact said lip shield and said lip shield substantially prevents air from being released through said wearer's lips.

2. (canceled)

3. The device of claim 1, wherein said lip shield is attached to a device for providing CPAP therapy.

4. (canceled)

5. The device of claim 1, wherein said lip shield is made from plastic.

6. The device of claim 1, wherein said lip shield is custom molded to fit said wearer's lips.

7. The device of claim 1, wherein said upper mouth piece is custom molded to fit said wearer's upper arch.

8. A device comprising:
a nasal mask;
a frame, wherein said frame is coupleable to said nasal mask such that air under pressure is supplied to said nasal mask through said coupling; and
a lip shield attached to an upper mouth piece such that when said upper mouth piece is positioned on said wearer's upper arch, said lip shield extends upwardly and downwardly to at least the vermillion border of said wearer's upper and lower lips, such that when said wearer's lips are in a pressurized position said upper and lower lips contact said lip shield and said lip shield substantially prevents air from being released through said wearer's lips.

9. The device of claim 8, further comprising a coupling between said lip shield and said frame.

10. The device of claim 8 further comprising at least one strap attached to said frame for retaining said frame on said wearer's head.

11. A method comprising:
placing an upper mouth piece on the upper arch of a wearer, said upper mouth piece being attached to and spaced from a lip shield positioned outside said wearer's mouth such that said lip shield extends upwardly and downwardly to at least the vermillion border of said wearer's upper and lower lips, and such that when said wearer's lips are in a pressurized position said upper and lower lips contact said lip shield and said lip shield substantially prevents air from being released through said wearer's lips.

12. The method of claim 11 further comprising attaching said lip shield to a CPAP therapy device.

13. A method comprising:
custom molding an upper mouth piece to fit the upper arch of a wearer;
custom molding a lip shield to fit the upper and lower lips of said wearer; and
attaching said upper mouth piece to and spaced from said lip shield, such that said upper mouth piece is positionable on said wearer's upper arch, said lip shield is positionable outside said wearer's mouth and extends vertically to at least the vermillion border of said wearer's upper and lower lips, such that when said wearer's lips are in a pressurized position said upper and lower lips contact said lip shield and said lip shield substantially prevents air from being released through said wearer's lips.

14. A device comprising a lip shield attached to and spaced from an upper mouth piece such that when said upper mouth piece is positioned on a wearer's upper arch, said lip shield is positioned outside said wearer's mouth and extends to at least the vermillion border of said wearer's upper and lower lips, such that when said wearer's lips are in a pressurized position, said upper and lower lips contact said lip shield and said lip shield substantially prevents air from being released through said wearer's lips, wherein said lip shield is attached to said upper mouth piece by wires at opposite ends of said upper mouth piece such that said wires extend between said wearer's upper and lower lips.

15. A device comprising a lip shield attached to and spaced from an upper mouth piece such that when said upper mouth piece is positioned on a wearer's upper arch, and a releasable coupling attached between said lip shield and a CPAP therapy device, wherein said lip shield is positioned outside said wearer's mouth and extends to at least the vermillion border of said wearer's upper and lower lips, such that when said wearer's lips are in a pressurized position, said upper and lower lips contact said lip shield and said lip shield substantially prevents air from being released through said wearer's lips.
